(19) United States
(12) Patent Application Publication
(10) Pub. No.: US 2014/0369622 A1
(43) Pub. Date: Dec. 18, 2014

(54) IMAGE COMPLETION BASED ON PATCH OFFSET STATISTICS

(71) Applicant: Microsoft Corporation, Redmond, WA (US)

(72) Inventors: Kaiming He, Beijing (CN); Jian Sun, Beijing (CN)

(21) Appl. No.: 14/297,530

(22) Filed: Jun. 5, 2014

Related U.S. Application Data
(63) Continuation of application No. PCT/CN2013/077146, filed on Jun. 13, 2013.

(51) Int. Cl. G06T 5/00

(52) U.S. Cl. CPC G06T 5/005
USPC 382/266

(57) ABSTRACT

An image completion system receives an input image that includes an unknown region to be filled. Upon receiving the image, the image completion system examines a known region of the image other than the unknown region and matches a plurality of patches that are obtained from the known region. The image completion system determines a plurality of offsets associated with the matching and computes statistics associated with these offsets. Based on a subset of the offsets, the image completion system locates features in the known region that are used to fill the unknown region and corresponding offsets based on an energy function and an optimization algorithm. Upon locating the features, the image completion system fills the unknown region based on the located features and the corresponding offsets.

### RELATED APPLICATION

This application is a continuation of PCT International Application No. PCT/CN2013/077146, filed Jun. 13, 2013, which is incorporated herein by reference.

### BACKGROUND

With the ease of image production and the advent of computer technologies, an increasing number of people are now able to edit images using different image processing tools. Image completion is one image processing tool that enables a user to fill in missing parts of an image by determining possible image details that may be included in the missing parts. For instance, a user may be able to fill in parts of a photo that is torn or worn. In some instances, the image completion may further be employed to recreate parts that are hidden behind one or more objects in the image. This technology of image completion, however, is a non-trivial task in the computer vision/graphics field due to the inherent complexity or uncertainty involved in the determination of image details that may represent missing parts in an image.

Although a number of image completion algorithms have been developed, these image completion algorithms are either computationally intensive or labor-intensive (i.e., involving a lot of user interactions or judgments). Furthermore, results produced by these image completion algorithms often include artifacts or imperfections that are in discord with remaining parts of corresponding images. Moreover, these image completion algorithms usually impose a limitation on the sizes of missing parts to be filled or a large error or discrepancy may result.

### SUMMARY

This summary introduces simplified concepts of image completion, which are further described below in the Detailed Description. This summary is not intended to identify essential features of the claimed subject matter, nor is it intended for use in limiting the scope of the claimed subject matter.

This application describes example embodiments of image completion. In one embodiment, an image including an unknown region is received. The unknown region may include or enclose a region that is blocked by an object, a region that is blurred and/or a region that is missing from the image. In one embodiment, in response to receiving the image, a plurality of patches within a known region of the image are matched with one another to obtain a plurality of offsets. The known region may include a region other than the unknown region or a region indicated by a user to include image features that may be similar or relevant to missing features in the unknown region. Statistics associated with the plurality of offsets, such as a respective number of times or occurrences that each offset is obtained, are computed. These statistics are then used for selecting image features to complete the unknown region of the image.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 illustrates an example environment of an image completion system.

FIG. 2 illustrates the image completion system of FIG. 1 in more detail.

FIG. 3A-3E illustrate an example image completion algorithm using the image completion system of FIG. 1.

FIG. 4 illustrates an example method of image completion.

### DETAILED DESCRIPTION

### Overview

As noted above, existing image completion algorithms are computationally intensive and/or labor-intensive. Furthermore, an image produced by these image completion algorithms often includes artifacts or imperfections that are in discord with remaining parts of the image.

This disclosure describes an image completion system. The image completion system enables filling or completing a missing part of an image with little or no user interaction.

In one embodiment, the image completion system receives an image that includes an unknown region or area to be completed or filled. For instance, the image may include a scan of a photograph that is worn or torn. In another example, the image may include a region that is hidden. In response to receiving the image, the image completion system may determine the unknown region or area to be completed or filled and a known region different from the unknown region in the image. The known region may include remaining regions other than the unknown region.

Upon determining the known region, the image completion system may obtain a plurality of patches from the known region and match each patch to other patches based on a similarity metric or measure. The image completion system may find a patch that is most similar to another patch and determine an offset between these two patches. In one embodiment, the image completion system may impose an offset threshold or a non-nearby constraint to preclude any two patches separated by less than the offset threshold or non-nearby constraint from matching with each other. The image completion system imposes this offset threshold or non-nearby constraint to avoid obtaining a trivial result that a patch will most probably match to another patch that is located nearby. In one embodiment, the offset between two patches is a vector including a direction and a magnitude, pointing from a patch to be matched to a matching patch.

Upon matching the plurality of patches and obtaining respective offsets of each patch, the image completion system may determine or compute statistics associated with the obtained offsets. For example, the image completion system may count a number of times or occurrences that each offset appears among the offsets. In one embodiment, the image completion system may obtain a two-dimensional histogram of the offsets. The image completion system may select a certain number of dominant offsets corresponding to the first N highest peaks in the histogram, wherein N is an integer greater than zero. Additionally or alternatively, the image completion system may select a number of dominant offsets that at least include or cover a certain percentage of all determined offsets. In one embodiment, the number of dominant offsets is less than all available offsets determined for the plurality of patches. The image completion system may use this number of dominant offsets as an offset pool from which the image completion system may select for determining which feature in the known region to complete or fill into a certain location in the unknown region.

After selecting a number of dominant offsets, the image completion system may determine which features (e.g., pixels or groups of pixels) in the known region are to be filled into the unknown region based on an optimization function. The optimization function may include the selected number of dominant offsets as parameters which the image completion system uses to optimize the optimization function. Upon determining which offsets (and hence which features in the known region) are used to complete or fill into which locations of the unknown region, the image completion system may fill the determined features into the unknown region to form a completed image.

The described image completion system automatically determines which features are to be filled into an unknown region to be completed with little or no interaction from a user, thereby achieving automated completion of images. Furthermore, by using dominant offsets rather than an entire set of available offsets, the image completion system speeds up an associated image completion process while still achieving a reasonably good quality of image completion for the images.

In the examples described herein, the image completion system receives an image including an unknown region, determines a known region, obtains a plurality of patches in the known region, matches each patch to another patch in the known region, determines offsets associated with the plurality of patches, obtains statistics associated with the offsets, optimizes a function based on the statistics, and completes the image based on the optimized function. However, in other embodiments, these functions may be performed by one or more services. For example, in one embodiment, a pre-processing service may receive an image, determine a known region and obtain a plurality of patches in the known region, while a separate service may match each patch to another patch in the known region, determine offsets associated with the plurality of patches and obtain statistics associated with the offsets. Yet another service may optimize a function based on the statistics, and complete the image based on the optimized function.

Furthermore, although in the examples described herein, the image completion system may be implemented as software and/or hardware installed in a single device, in other embodiments, the image completion system may be implemented and distributed in multiple devices or as services provided in one or more servers over a network and/or in a cloud computing architecture.

The application describes multiple and varied implementations and embodiments. The following section describes an example framework that is suitable for practicing various implementations. Next, the application describes example systems, devices, and processes for implementing an image completion system.

### Exemplary Environment

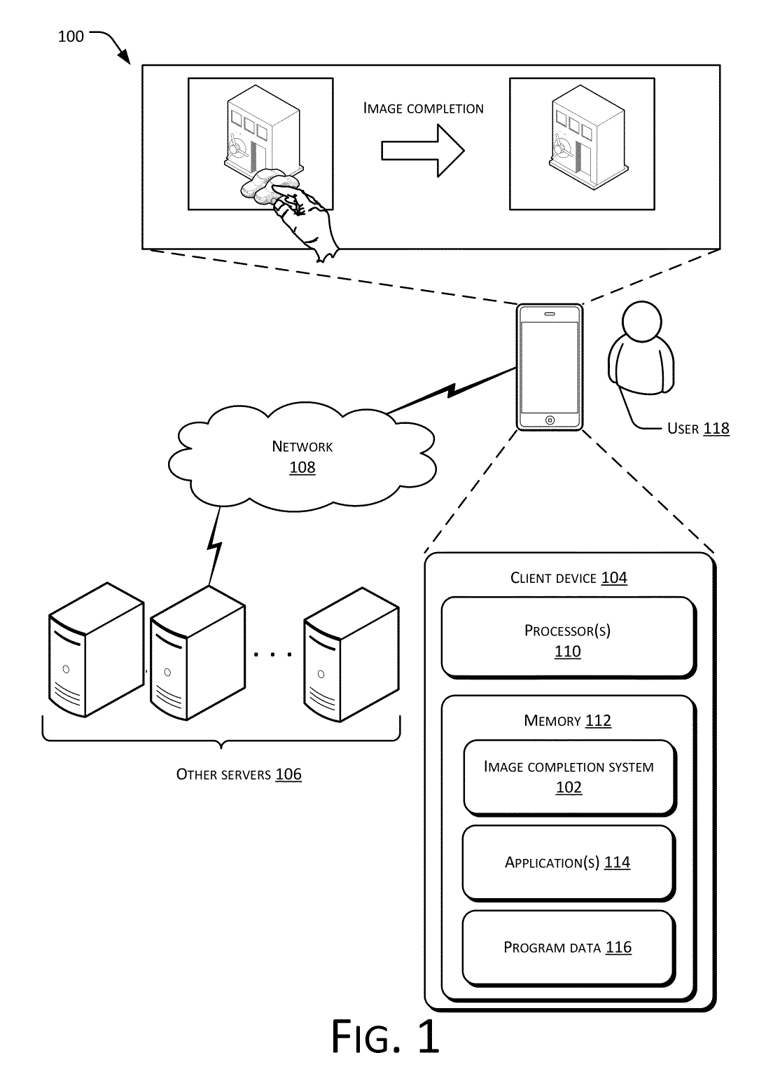

FIG. 1 illustrates an exemplary environment 100 usable to implement an image completion system. The environment 100 may include an image completion system 102. In this example, the image completion system 102 is described to be included in a client device 104. In other instances, the image completion system 102 may be implemented in whole or in part at one or more servers 106 that may communicate data with the client device 104 via a network 108. Additionally or alternatively, some or all of the functions of the image completion system 102 may be included and distributed among the client device 104 and the one or more servers 106 via the network 108. For example, the one or more servers 106 may include part of the functions of the image completion system 102 while other functions of the image completion system 102 may be included in the client device 104. Furthermore, in some embodiments, some or all the functions of the image completion system 102 may be included in a cloud computing system or architecture.

The client device 104 may be implemented as any of a variety of conventional computing devices including, for example, a mainframe computer, a server, a notebook or portable computer, a handheld device, a netbook, an Internet appliance, a tablet or slate computer, a mobile device (e.g., a mobile phone, a personal digital assistant, a smart phone, etc.), a gaming console, a set-top box, etc. or a combination thereof.

The network 108 may be a wireless or a wired network, or a combination thereof. The network 108 may be a collection of individual networks interconnected with each other and functioning as a single large network (e.g., the Internet or an intranet). Examples of such individual networks include, but are not limited to, telephone networks, cable networks, Local Area Networks (LANs), Wide Area Networks (WANs), and Metropolitan Area Networks (MANs). Further, the individual networks may be wireless or wired networks, or a combination thereof.

In one embodiment, the client device 104 may include one or more processors 110 coupled to memory 112. The memory 112 may include one or more applications or services 114 (e.g., an image editing application, etc.) and program data 116. The memory 112 may be coupled to, associated with, and/or accessible to other devices, such as network servers, routers, and/or the servers 106.

In one embodiment, a user 118 may edit an image using the application 114 (e.g., the image editing application) which is supported by the image completion system 102. The user 118 may provide an image including an unknown region to be completed or filled to the application 114 which may perform image completion through the image completion system 102 and return a completed or resulting image to the user 118.

### Exemplary Image Completion System

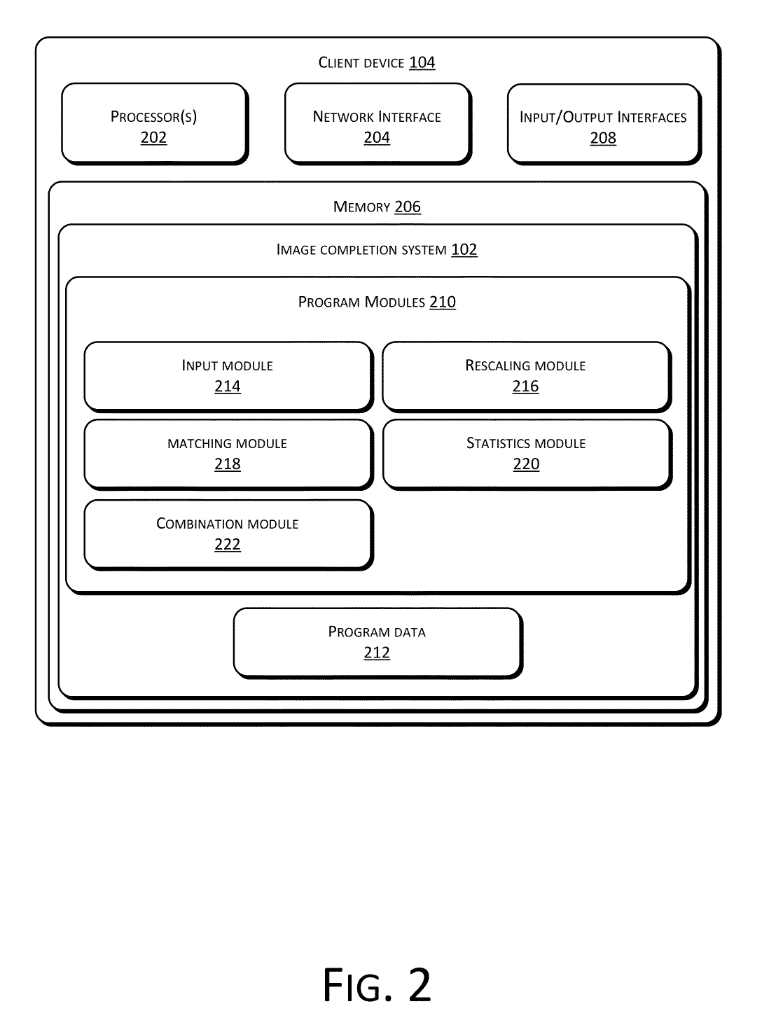

FIG. 2 illustrates the client device 104 that includes the image completion system 102 in more detail. In one embodiment, the client device 104 includes, but is not limited to, one or more processors 202 (which correspond to the one or more processors 110 in FIG. 1), a network interface 204, memory 206 (which corresponds to the memory 112 in FIG. 1), and an input/output interface 208. The processor(s) 202 is configured to execute instructions received from the network interface 204, received from the input/output interface 208, and/or stored in the memory 206.

The memory 206 may include computer-readable media in the form of volatile memory, such as Random Access Memory (RAM) and/or non-volatile memory, such as read only memory (ROM) or flash RAM. The memory 206 is an example of computer-readable media. Computer-readable media includes at least two types of computer-readable media, namely computer storage media and communications media.

Computer storage media includes volatile and non-volatile, removable and non-removable media implemented in any method or technology for storage of information such as computer readable instructions, data structures, program modules, or other data. Computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device.

In contrast, communication media may embody computer readable instructions, data structures, program modules, or other data in a modulated data signal, such as a carrier wave, or other transmission mechanism. As defined herein, computer storage media does not include communication media.

In some embodiments, some or all of the functionalities of the image completion system 102 may be implemented using an ASIC (i.e., Application-Specific Integrated Circuit), a GPU (i.e., Graphics Processing Unit) or other hardware. For example, a patch matching algorithm and a Graph-Cut algorithm (such as Multi-Label Graph Cuts), which will be described hereinafter, may be implemented in one or more GPUs.

Without loss of generality, an image editing application is used hereinafter as an example of the application 114 with which the user 118 performs image completion for an image. It is noted, however, that the present disclosure is not limited thereto and can be applied to other applications, such as image viewing application, a slide presentation application, a photo catalog application, etc.

In one embodiment, the image completion system 102 may include program modules 210 and program data 212. The program modules 210 may include an input module 214 that receives an image including an unknown region. The unknown region may include or enclose a region to be filled or completed, which includes, for example, a region that has been masked, a region that is blocked by one or more objects in the image, a region that is blurred and/or a region that is missing from the image. In some embodiments, the input module 214 may further receive information related to the unknown region. By way of example and not limitation, the information related to the unknown region may include, but is not limited to, location or coordinate information of the unknown region, size information of the unknown region, etc. In one embodiment, the input module 214 may receive this information interactively from the user 118 through a user interface (e.g., a user interface provided by the application 114, etc.) that enables the user 118 to select or enclose the unknown region that is to be completed or filled. In some embodiments, the information may be included in or attached with the image and the input module 214 may receive or extract this information from the image.

In one embodiment, the image completion system 102 may further include a scaling module 216. The scaling module 216 may determine a size and/or a resolution of the image, and rescale the size and/or the resolution of the image to a target size and/or a target resolution (or a target size range and/or a target resolution range). The target size and/or the target resolution (or the target size range and/or the target resolution range) may be predefined by the image completion system 102 or defined interactively by the user 118 (e.g., through the user interface provided by the application 114). In one embodiment, if the size or resolution of the image is larger than the target size or resolution (or outside the size range or resolution range), the scaling module 216 may down-sample the image to a smaller size or a lower resolution in order to reduce processing times in subsequent processing stages. In other embodiments, the image completion system 102 may directly act on the image without rescaling the image.

Additionally or alternatively, the image completion system 102 may include a matching module 218. The matching module 218 may determine a known region of the image. In one embodiment, the known region may include remaining parts of the image other than the unknown region. Additionally or alternatively, the known region may include a region indicated by the user 118 (e.g., through the user interface provided by the application 114, etc.). In some embodiments, the known region may include regions on the left and/or right of the unknown regions. Additionally or alternatively, the known region may include regions above and/or below the unknown region. The matching module 218 may determine that these regions (i.e., regions on the left, right, above and/or below the unknown region) may include features and/or patterns that are similar to features and/or patterns missing or hidden in the unknown region.

After determining the known region of the image, the matching module 218 may obtain a plurality of patches from the known region. In one embodiment, the matching module 218 may partition the known region into a plurality of patches with or without overlapping. By way of example and not limitation, the matching module 218 may partition or obtain a plurality of patches, a center of each patch being separate from a center of a closest neighboring patch thereof by a distance threshold (e.g., one pixel, two pixels, etc.). In one embodiment, the matching module 218 may define this distance threshold based on a tradeoff between a processing speed and an accuracy of the image completion. In some embodiments, the matching module 218 may further define a size (M×M) of each patch, which may additionally or alternatively be defined by the user 118 interactively through the user interface provided by the application 114, for example.

Upon obtaining the plurality of patches from the known region, the matching module 218 may match similar patches and obtain respective offsets. When matching the plurality of patches, the matching module 218 may include an offset threshold or a non-nearby constraint to avoid a patch from matching a nearby patch. Without this offset threshold or non-nearby constraint, the matching module 218 may find a best match of a patch that is most probably located near to the patch, resulting in a distribution of offsets that is favorably peaked or concentrated at zero or small offsets. This may sometimes create an issue if the unknown region has a moderately large size where some locations of the unknown region that are to be filled may be located away from a boundary of the unknown region by a distance greater than most of the small offsets if the offset threshold or non-nearby constraint is not used. The matching module 218 may therefore include this offset threshold or non-nearby constraint to preclude this trivial result or distribution. Furthermore, this offset threshold or non-nearby constraint enables the matching module 218 to exploit pattern or feature similarity that is of a medium to long range, allowing determination of a feature or pattern in the known region to represent a missing or hidden feature or pattern in the unknown region when the missing or hidden feature or pattern is further away from the boundary of the unknown region or when the size of the unknown region is large.

In one embodiment, the matching module 218 may match each patch to a patch that is most similar thereto based on a similarity measure or metric. An example of the similarity measure or metric may include, for example, the following metric:

s(x)=arg minₛ∥P(c+s)−P(c)∥² s.t.|s|>τ (1)

where s=(u, v) represents a two-dimensional coordinate (or a two-dimensional vector) of an offset, c=(x, y) represents a center position of a patch and P(c) represents a patch centered at c. τ represents an offset threshold or a non-nearby constraint used to exclude patches that are nearby a patch from similarity consideration and hence avoid trivial offset statistics.

Although in this example, the similarity metric used in Equation (1) measures a degree of similarity between two patches based on a sum of squared differences between values of corresponding pixels of the two patches, in other embodiments, the matching module 218 may use a different similarity metric, such as a sum of absolute differences, etc., for measuring or determining a degree of similarity between two patches.

In response to matching the similar patches and obtaining a plurality of offsets, a statistics module 220 may compute statistics associated with the plurality of offsets. In one embodiment, the statistics module 220 may determine or count a number of times or occurrences that each offsets appears in the plurality of offsets. For example, the statistics module 220 may compute a two-dimensional histogram h(u, v) based on the following equation:

h(u, v)=Σ_{c}δ(s(c)=(u, v)) (2)

where δ(·) is one when an argument thereof is true and zero otherwise.

In one embodiment, the statistics module 220 may determine that the offsets are sparsely distributed with most of the plurality of offsets falling as one of a few offset values. In one embodiment, the statistics module 220 may select a predetermined number of offsets from the plurality of offsets. For example, the statistics module 220 may select K highest peaks of the histogram h(u, v) which correspond to K dominant offsets, where K is an integer greater than zero. In some embodiments, the statistics module 220 may select a sparse number of dominant offsets (or offset values) that cover or include a defined percentage of the plurality of offsets.

Additionally or alternatively, the statistics module 220 may divide a distribution of the plurality of offsets (e.g., the histogram h(u, v)) into a plurality of sections and assign a probability to each section based on the number of offsets (obtained by the matching module 218) that are found in each section. For example, the statistics module 220 may assign a higher probability to a section that includes a higher number of offsets obtained by the matching module 218. The statistics module 220 may then probabilistically select a predetermined number of sections.

After selecting the predetermined number of sections, the statistics module 220 may select a corresponding number of dominant offsets in each selected section (e.g., corresponding highest peaks in each selected section in the histogram h(u, v))). For example, if the statistics module 220 has selected a certain section for M number of times (where M is a positive integer), the statistics module 220 may select the first M highest peaks from that section of the histogram. This enables that the statistics module 220 may still have a chance to select less dominant offsets (and hence patterns or feature correlations in the image) which may be features or patterns to be filled into the unknown region. This is especially true if the image (or the known region) predominantly includes certain features or patterns while features or patterns hidden or missing in the unknown region may include features or patterns that are less dominant in the image (or the unknown region).

In one embodiment, prior to selecting the certain number of offsets (or offset values), the statistics module 220 may apply a smoothing filter (e.g., a Gaussian filter, etc.) to the histogram to smooth out the histogram. The statistics module 220 may then select first K highest peaks that correspond to K most dominant offsets (or offset values) from the histogram, for example.

Upon selecting a given number of offsets (e.g., K most dominant offsets), a combination module 222 of the image completion system 102 may determine which image feature or pattern to be filled or completed into the unknown region based on these selected offsets. In one embodiment, the combination module 222 may treat image completion as a photomontage problem, i.e., filling the unknown region by combining multiple shifted images. By way of example and not limitation, the combination module 222 may optimize the following optimization or energy function:

E(L)=Σ_{x∈Ω}E_{d}(L(x))+Σ_{(x,x′)|x∈Ω,x′∈Ω′}Eₛ(L(x),L(x′)) (3)

where Ω and Ω′ represent the unknown region (with boundary conditions), (x, x′) are four-connected neighbors, L represents a labeling with corresponding label representing pre-selected offsets {sᵢ}ᵢ₌₁^{K} or s₀=(0,0), where s₀ happens on boundary pixels only. Specifically, L(x)=i represents that a pixel at x+sᵢ is copied to a location x in the unknown region.

In one embodiment, the data term E_{d} is defined to be zero if a label L(x) therein is valid (i.e., x+s is a pixel in the unknown region) or is defined to have an infinite value (e.g., +∞) otherwise. Furthermore, the combination module 222 may employ the smoothness term Eₛ to penalize incoherent seams. For example, if a=L(x) and b=L(x′), the combination module 222 may define Eₛ as:

Eₛ(a, b)=∥I(x+sₐ)−I(x+s_{b})∥²+∥I(x′+sₐ)−I(x′+s_{b})∥² (4)

where I(x) is pixel value (e.g., RGB color values if the image is a color image, etc.) at location x. I(·+s) represents a shifted image given a fixed s.

If sₐ≠s_{b}, a seam or an incoherent seam exists between x and x′. The combination module 222 thus penalizes such a seam (through the smoothness term Eₛ(a, b) in Equation (4)) recognizing that two shifted images I(·+sₐ) and I(·+s_{b}) are not similar near this seam.

In one embodiment, the combination module 222 may optimize the function described in Equation (3) using an optimization algorithm. An example of the optimization algorithm may include, for example, Multi-Label Graph Cuts. Details of a Multi-Label Graph Cuts algorithm can be found at “Fast Approximate Energy Minimization via Graph Cuts,” authored by Y. Boykin, O. Veksler, R. Zabih, TPAMI (2001), pages 1222-1239.

Upon finding respective offsets for filling features or patterns (e.g., pixels or groups of pixels) in the unknown region, the combination module 222 may fill or complete the unknown region based on features or patterns that are located in the known region. For example, the combination module 222 may fill or complete a location in the unknown region with a feature or pattern that is located in the known region and separated from the location by a respective offset as determined in Equation (4). By filling each location in the unknown region with a corresponding feature or pattern of the unknown region, the combination module 222 completes image filling or completion of the unknown region for this image.

In one embodiment, in an event that the image completion system 102 or the rescaling module 216 has previously rescaled the image, the rescaling module 216 may herein rescale (e.g., up-sample) the image back to its original size or resolution. For example, the rescaling module 216 may up-sample a resulting image back to the original size or resolution (by a up-sampling scale that is a reciprocal of the down-sampling scale) after image completion by the combination module 222. The rescaling module 216 may employ an up-sampling method such as a nearest-neighbor interpolation and multiply each determined offset accordingly by a same up-sampling scale. Furthermore, in one embodiment, in order to correct small misalignments, the combination module 222 may further optimize the energy function as described in Equation (4) in the original size of resolution of the image, and allow each feature or pattern (e.g., pixel) to take or select one of a predetermined number of offsets. For example, the combination module 222 may allow each feature or pattern to select one of the corresponding up-sampled offset and four relative offsets (e.g., if a corresponding up-sampled offset is (u, v), the other four relative offsets may be (u±½, v) and (u, v±½)). In one embodiment, the combination module 222 may only solve for pixels that are within one-half pixel around the seams. Additionally or alternatively, the combination module 222 may further apply a Poisson fusion or a smoothing filter to hide small seams.

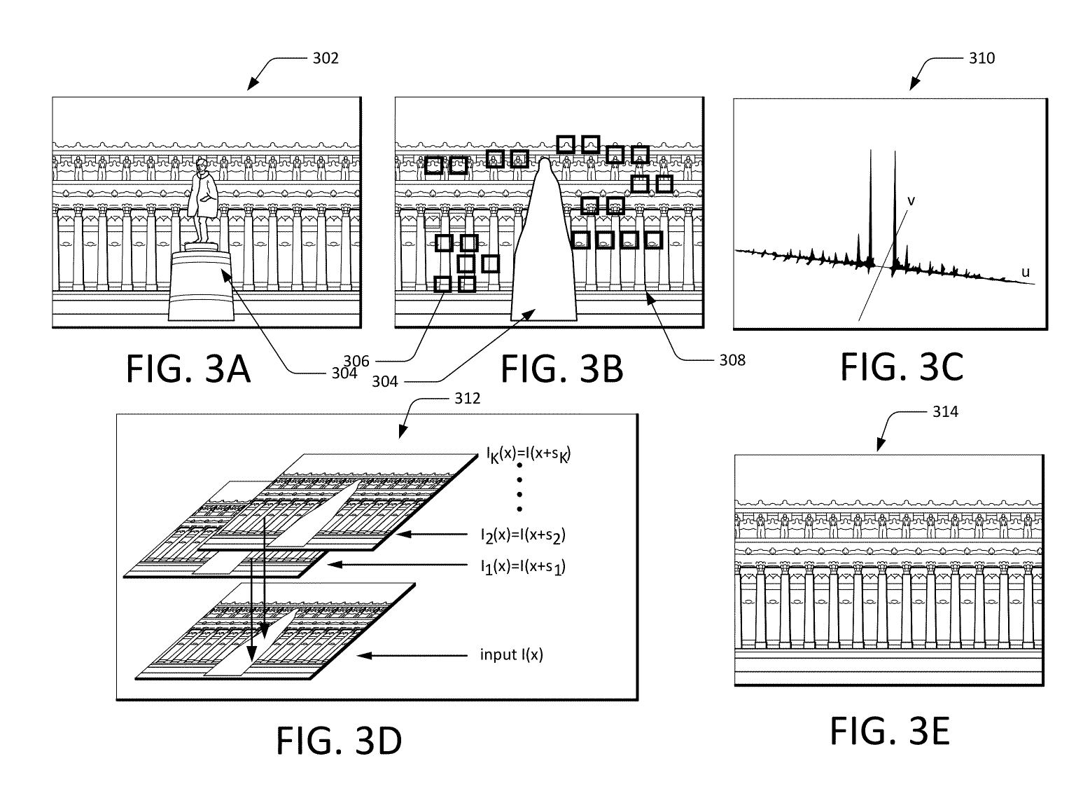

FIGS. 3A-3E show the example image completion algorithm described above using the image completion system 102. FIG. 3A shows an example image 302 received by the image completion system 102. The example image 302 includes a masked region 304 (i.e., an unknown region) which is to be completed or filled. Upon receiving the example image 302, the image completion system 102 matches a plurality of patches 306 in a known region 308 as shown in FIG. 3B and obtain a plurality of offsets. FIG. 3C shows statistics (in this example, a histogram 310) associated with the plurality of offsets that are obtained by the image completion system 102. This figure illustrates a sparse distribution of the plurality of offsets obtained by the image completion system 102. After obtaining the statistics of the plurality of offsets and selecting a number of dominant offsets from the statistics, the image completion system 102 determines which features in the known region to be used for filling which locations in the unknown region based on an optimization function as described in the foregoing embodiments. FIG. 3D shows a resulting image montage 312 found by the image completion system 102 for filling or completing the unknown region of the example image. A resulting image 314 obtained by the image completion system 102 after image completion is shown in FIG. 3E. As can be seen in the figure, the resulting image 314 reasonably shows an image region that may exist behind the scene after the masked region 304 is removed from the example image.

### Exemplary Methods

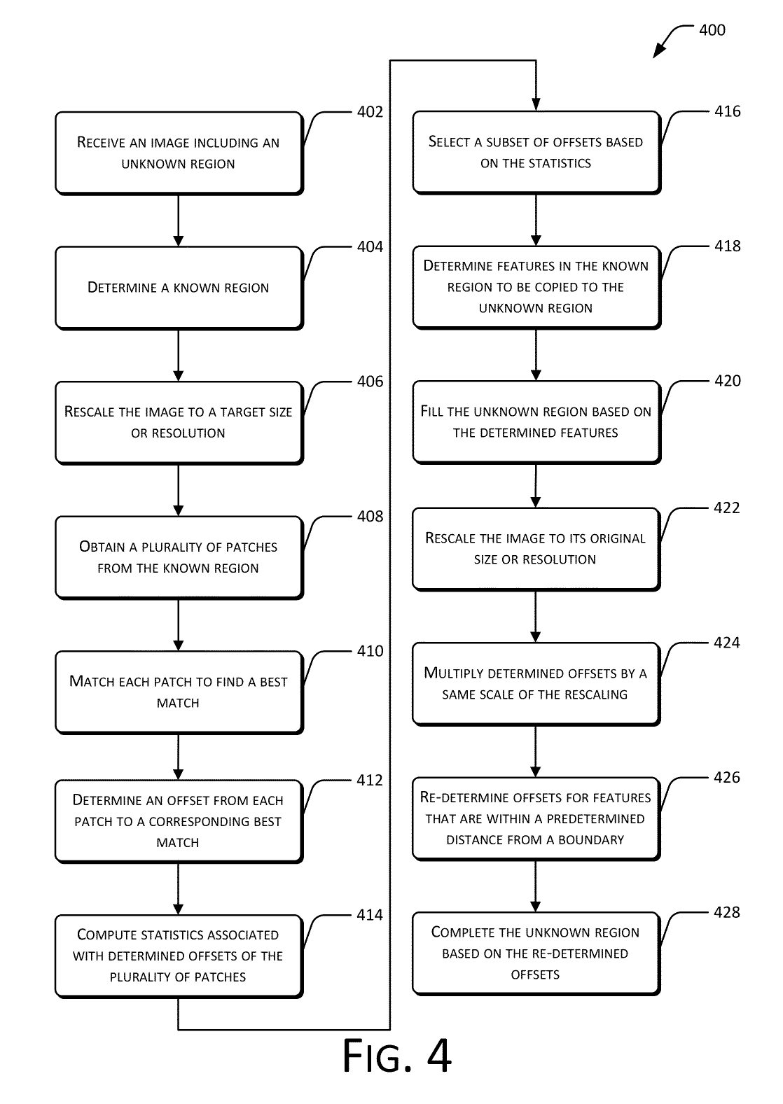

FIG. 4 is a flow chart depicting an example method 400 of image completion. The method of FIG. 4 may, but need not, be implemented in the environment of FIG. 1 and using the device of FIG. 2. For ease of explanation, method 400 is described with reference to FIGS. 1-2. However, the method 400 may alternatively be implemented in other environments and/or using other systems.

Method 400 is described in the general context of computer-executable instructions. Generally, computer-executable instructions can include routines, programs, objects, components, data structures, procedures, modules, functions, and the like that perform particular functions or implement particular abstract data types. The method can also be practiced in a distributed computing environment where functions are performed by remote processing devices that are linked through a communication network. In a distributed computing environment, computer-executable instructions may be located in local and/or remote computer storage media, including memory storage devices.

The exemplary method is illustrated as a collection of blocks in a logical flow graph representing a sequence of operations that can be implemented in hardware, software, firmware, or a combination thereof. The order in which the method is described is not intended to be construed as a limitation, and any number of the described method blocks can be combined in any order to implement the method, or alternate methods. Additionally, individual blocks may be omitted from the method without departing from the spirit and scope of the subject matter described herein. In the context of software, the blocks represent computer instructions that, when executed by one or more processors, perform the recited operations. In the context of hardware, some or all of the blocks may represent application specific integrated circuits (ASICs) or other physical components that perform the recited operations.

Referring back to FIG. 4, at block 402, the image completion system 102 receives an image which includes an unknown region to be completed or filled. In one embodiment, the unknown region may include, for example, a region that is blocked by an object, a region that is blurred and/or a region that is missing from the image. In some embodiment, the image completion system 102 may further receive information indicating a location and/or a size of the unknown region to be completed.

At block 404, the image completion system 102 may determine a known region of the image. For example, the image completion system 102 may determine that the known region includes remaining regions of the image other than the unknown region. The known region may include a pattern or feature that is expected to be present in the unknown region.

At block 406, the image completion system 102 may optionally rescale the image to a target size or resolution (or to a size or resolution within a target size range or resolution range). For example, if a size or resolution of the image is greater than a predetermined threshold, the image completion system 102 may down-sample the image to the target size or resolution (or to a size or resolution within the target size range or resolution range) in order to reduce subsequent processing times. In other embodiments however, the image completion system 102 may perform image completion without rescaling the image.

At block 408, the image completion system 102 partitions or obtains a plurality of patches from the known region.

At block 410, the image completion system 102 matches each patch to find a corresponding best match. For example, the image completion system 102 find match a patch in the known region that is most similar to each patch based on a similarity metric or measure. In one embodiment, the similarity metric or measure may include, but is not limited to, a measure of a sum of squared differences or a measure of a sum of absolute differences, etc. The image completion system 102 selects a patch that has a highest degree of similarity for each patch according to the similarity metric or measure. Additionally, the image completion system 102 may impose a non-nearby constraint or an offset threshold to preclude a patch from matching another patch that is nearby.

At block 412, the image completion system 102 determines respective offsets between each patch and corresponding matched patch. Each offset may include a relative distance between two patches and a direction pointing from a patch to be matched and a matching patch.

At block 414, the image completion system computes statistics associated with the offsets obtained for the plurality of patches. In one embodiment, the image completion system may count a respective number of times or occurrences that each offset of the offsets is obtained from the matching. In some embodiments, the image completion system 102 may compute a histogram which represents a number of times or occurrences each offset of the offsets being obtained from the matching. The image completion system 102 may determine that the offsets are sparsely distributed.

At block 416, the image completion system 102 selects a subset of the offsets for subsequent operations of image completion based on the computed statistics. In one embodiment, the image completion system 102 may select a plurality of dominant offsets from the offsets based on a respective number of times or occurrences of each offset. Additionally or alternatively, the image completion system 102 may select a plurality of dominant offsets which numbers of times or occurrences are among first N highest ones of the counted numbers of times or occurrences (or first N highest peaks in the histogram), wherein N is an integer greater than zero. Additionally or alternatively, the image completion system 102 may select a plurality of dominant offsets which include or cover a predetermined percentage of a total number of the offsets.

At block 418, the image completion system 102 determines which features or patterns in the known region to be copied to which locations in the unknown regions for image filling or completion. In one embodiment, the image completion system may employ an optimization or energy function with the selected offsets as parameters of the function while those offsets that are not selected are excluded from consideration in optimizing the function. The function may include a data term and a smoothness term which penalizes incoherent seams between nearby features that are under consideration to be filled into the unknown region. The image completion system 102 may optimize the function based on an optimization algorithm such as Multi-Label Graph Cuts.

At block 420, upon determining which features or patterns (e.g., pixels) to be copied to which locations in the unknown region (and hence respective offsets), the image completion system 102 completes or fills the unknown region using the determined features or patterns based on the respective determined offsets.

At block 422, if the image completion system 102 has down-sampled the image previously, the image completion system 102 may up-sample the image back to its original size or resolution.

At block 424, the image completion system 102 multiplies the respective determined offsets by a scale corresponding to a scale change from the down-sampled image to the up-sampled image.

At block 426, in some embodiments, the image completion system 102 may re-determine offsets for features (e.g., pixels) that are within a predetermined distance from a boundary between the unknown region and the other region in order to correct misalignments.

At block 428, the image completion system 102 may then complete the unknown region in the un-sampled image based on the re-determined offsets.

Any of the acts of any of the methods described herein may be implemented at least partially by a processor or other electronic device based on instructions stored on one or more computer-readable media. By way of example and not limitation, any of the acts of any of the methods described herein may be implemented under control of one or more processors configured with executable instructions that may be stored on one or more computer-readable media such as one or more computer storage media.

### Conclusion

Although embodiments have been described in language specific to structural features and/or methodological acts, it is to be understood that the claims are not necessarily limited to the specific features or acts described. Rather, the specific features and acts are disclosed as exemplary forms of implementing the claimed subject matter. Additionally or alternatively, some or all of the operations may be implemented by one or more ASICS, GPUs, or other hardware.

What is claimed is:

1. A method comprising:
under control of one or more processors configured with executable instructions:
matching a plurality of patches in a known region of an image to obtain a plurality of offsets, matching the plurality of patches comprising precluding each patch of the plurality of patches from matching to a nearby patch that is located within an offset threshold of each patch;
computing statistics associated with the plurality of offsets; and
completing an unknown region of the image by filling the unknown region based on the computed statistics.

2. The method as recited in claim 1, wherein the unknown region comprises a region that is blocked by an object, a region that is blurred or a region that is missing from the image.

3. The method as recited in claim 1, wherein an offset of the plurality of offsets represents a relative distance between a patch of the plurality of patches and a corresponding matched patch.

4. The method as recited in claim 1, matching the plurality of patches comprising:
for each respective patch of the plurality of patches,
determining a patch that is most similar to the respective patch based on a similarity measure; and
determining a respective offset between the respective patch and the determined patch.

5. The method as recited in claim 4, the similarity measure comprising:
a measure of a sum of squared differences between pixel values of the respective patch and pixel values of the determined patch; or
a measure of a sum of absolute differences between the pixel values of the respective patch and the pixel values of the determined patch.

6. The method as recited in claim 1, matching the plurality of patches comprising:
determining degrees of similarity between each patch and other patches of the plurality of patches; and
selecting a patch having a highest degree of similarity from the other patches for each patch.

7. The method as recited in claim 1, computing the statistics associated with the plurality of offsets comprising counting a respective number of times that each offset of the plurality of offsets is obtained from the matching.

8. The method as recited in claim 7, computing the statistics associated with the plurality of offsets further comprising selecting offsets for which numbers of times are among first N highest ones of the counted numbers of times, wherein N is an integer greater than zero.

9. The method as recited in claim 8, completing the unknown region of the image further comprising optimizing a function having the selected offsets as parameters of the function, wherein offsets of the plurality of offsets that are not selected are excluded from consideration in optimizing the function.

10. The method as recited in claim 1, the statistics associated with the plurality of offsets being sparsely distributed.

11. The method as recited in claim 1, further comprising receiving an indication of the known region from a user, the known region comprising a pattern or feature that is expected to be present in the unknown region.

12. One or more computer-readable media storing executable instructions that, when executed by one or more processors, cause the one or more processors to perform acts comprising:
matching patches in a region other than an unknown region of an image to obtain a plurality of offsets, each patch being matched to a patch that is at an offset greater than an offset threshold;
counting a respective number of occurrences that each offset of the plurality of offsets is obtained from the matching;
selecting a plurality of dominant offsets from the plurality of offsets based on the respective number of times of each offset, a total number of the plurality of dominant offsets being less than a total number of the plurality of offsets;
determining respective offsets from the plurality of dominant offsets for pixels in the unknown region based on a function that comprises the plurality of dominant offsets as parameters to be optimized; and
completing the pixels in the unknown region using respective pixels in the other region that are separated from the pixels in the unknown region by the respective offsets.

13. The one or more computer-readable media as recited in claim 12, the function comprising a smoothness portion that penalizes incoherent seams.

14. The one or more computer-readable media as recited in claim 12, further comprising receiving an indication of the unknown region in the image from a user.

15. The one or more computer-readable media as recited in claim 12, further comprising:
prior to matching the patches in the other region, down-sampling the image to a predetermined resolution; and
in response to completing the unknown region, up-sampling the down-sampled image to an original resolution.

16. The one or more computer-readable media as recited in claim 15, further comprising:
multiplying the respective offsets by a scale corresponding to a scale change from the down-sampled image to the up-sampled image;
re-determining offsets for pixels that are within a predetermined distance from a boundary between the unknown region and the other region, the re-determining configured to correct misalignments; and
completing the unknown region in the up-sampled image based on the re-determined offsets.

17. A system comprising:
one or more processors;
memory storing executable instructions that, when executed by the one or more processors, configure the one or more processors to perform acts comprising:
receiving an indication of an unknown region of an image to be completed;
matching a plurality of patches in a known region of the image to obtain a plurality of offsets;
computing a statistic associated with the plurality of offsets;
selecting a subset of the plurality of offsets based on the computed statistic;
determining respective offsets from the subset of the plurality of offsets for pixels in the unknown region based on a function that comprises the subset of the plurality of offsets as parameters to be optimized; and
completing the pixels in the unknown region using respective pixels in the other region that are separated from the pixels in the unknown region by the respective offsets.

18. The system as recited in claim 17, the plurality of offsets being sparsely distributed.

19. The system as recited in claim 17, the statistic comprising a histogram representing a number of occurrences of each offset of the plurality of offsets that is obtained from the matching.

20. The system as recited in claim 19, selecting the subset of the plurality of offsets comprising selecting first N highest ones among the number of occurrences of each offset of the plurality of offsets, wherein N is an integer greater than zero.
